(19) United States
(12) Patent Application Publication
(10) Pub. No.: US 2018/0316303 A1
(43) Pub. Date: Nov. 1, 2018

(54) SYSTEMS AND METHODS FOR CLEANING ARRAYS OF SOLAR PANELS

(71) Applicant: Alion Energy, Inc., Richmond, CA (US)

(72) Inventors: Sean Bailey, Emeryville, CA (US); Thomas Goehring, Berkeley, CA (US)

(21) Appl. No.: 15/957,210

(22) Filed: Apr. 19, 2018

Related U.S. Application Data
(60) Provisional application No. 62/488,504, filed on Apr. 21, 2017.

(51) Int. Cl. H02S 40/10; B08B 1/00; B08B 3/10

(52) U.S. Cl. CPC H02S 40/10; B08B 3/10; B08B 1/008; B08B 1/006

(57) ABSTRACT

Under one aspect, a system for cleaning an array of solar panels is provided. The system includes a drive system and a cleaning head that includes a fluid emitter configured to deposit fluid onto the solar panels; a wiper; a wiper support structure; and spaced first and second mechanical linkages that respectively couple first and second portions of the wiper to the wiper support structure partially independently of one another and partially independently of the wiper support structure such that the wiper sequentially substantially fully contacts each of the solar panels to wipe the deposited fluid from those solar panels as the drive system moves along the array.

### CROSS-REFERENCE TO RELATED APPLICATIONS

This application claims the benefit of U.S. Provisional Patent Application No. 62/488,504, filed Apr. 21, 2017, the entire contents of which are incorporated by reference herein.

### FIELD

This application relates to cleaning solar panels, e.g., solar photovoltaic panels.

### BACKGROUND

Solar photovoltaic panels at solar power plants get dirty over time, and the accumulation of foreign matter can block sunlight from reaching the photovoltaic cells. Soiling by foreign matter can cause a solar plant power output to degrade over time relative to output of a plant with clean panels. A sensible way to address this issue is to clean the solar panels.

### SUMMARY

Provided herein are systems and methods for cleaning arrays of solar panels, e.g., solar photovoltaic panels.

Under one aspect, a system for cleaning an array of solar panels is provided that includes a drive system movable along the array of solar panels, and a cleaning head coupled to the drive system and configured to sequentially clean the solar panels as the drive system moves along the array. The cleaning head can include a fluid emitter configured to deposit fluid onto the solar panels; a wiper; a wiper support structure; a first mechanical linkage; and a second mechanical linkage spaced apart from the first mechanical linkage. The first and second mechanical linkages respectively can couple first and second portions of the wiper to the wiper support structure partially independently of one another and partially independently of the wiper support structure such that the wiper sequentially substantially fully contacts each of the solar panels to wipe the deposited fluid from those solar panels as the drive system moves along the array.

In some configurations, the first and second mechanical linkages respectively include first and second hinges each rotatable about a respective axis. Optionally, the first and second hinges respectively are configured to inhibit movement of the first and second portions of the wiper about another respective axis. Additionally, or alternatively, responsive to the first section of the wiper experiencing an increased drag force, the first portion of the wiper optionally rotates via the first hinge to reduce the drag force.

In some configurations, the first mechanical linkage includes first and second links, and the second mechanical linkage includes third and fourth links. Optionally, the first, second, third, and fourth links are configured to inhibit movement of the wiper about an axis. Additionally, or alternatively, responsive to the first section of the wiper experiencing an increased drag force, the first portion of the wiper optionally rotates via the first and second linkages to reduce the drag force.

In some configurations, the first portion of the wiper includes a first end of the wiper, and the second portion of the wiper includes a second end of the wiper.

Some configurations optionally include a third mechanical linkage spaced apart from and disposed between the first and second mechanical linkages.

In some configurations, the cleaning head optionally further includes a spring configured to press the wiper downward against respective surfaces as the drive system moves along the array.

In some configurations, the cleaning head optionally further includes a damper configured to resist downward motion of the wiper. Optionally, the damper is configured to retard a swinging motion of the wiper at gaps between the solar panels as the drive system moves along the array.

Under another aspect, a method for cleaning an array of solar panels is provided that includes sequentially moving a cleaning head across the solar panels of the array, and depositing, by the cleaning head, fluid onto the solar panels. Additionally, the method includes, while sequentially moving the cleaning head across the solar panels of the array, sequentially removing, by a wiper of the cleaning head, the deposited fluid from respective solar panels. The cleaning head can include a wiper support structure, a first mechanical linkage, and a second mechanical linkage spaced apart from the first mechanical linkage. The first and second mechanical linkages respectively can couple first and second portions of the wiper to the wiper support structure partially independently of one another and partially independently of the wiper support structure such that the wiper sequentially substantially fully contacts each of the solar panels to wipe the deposited fluid from those solar panels as the cleaning head moves across the solar panels.

In some configurations, the first and second mechanical linkages optionally respectively include first and second hinges each rotatable about a respective axis. Optionally, the first and second hinges respectively inhibit movement of the first and second portions of the wiper about another a respective axis. In some configurations, responsive to the first section of the wiper experiencing an increased drag force, the first portion of the wiper rotates via the first hinge to reduce the drag force.

In some configurations, the first mechanical linkage optionally includes first and second links; and the second mechanical linkage optionally includes third and fourth links. Optionally, the first, second, third, and fourth links inhibit movement of the wiper about an axis. Additionally, or alternatively, responsive to the first section of the wiper experiencing an increased drag force, the first portion of the wiper optionally rotates via the first and second linkages to reduce the drag force.

In some configurations, optionally the first portion of the wiper includes a first end of the wiper, and the second portion of the wiper includes a second end of the wiper.

In some configurations, the cleaning head optionally further includes a third mechanical linkage spaced apart from and disposed between the first and second mechanical linkages.

In some configurations, the cleaning head further includes a spring pressing the wiper downward against respective surfaces as the cleaning head moves across the solar panels of the array.

In some configurations, the cleaning head further includes a damper resisting downward motion of the wiper. Optionally, the damper retards a swinging motion of the wiper at gaps between the solar panels as the cleaning head moves across the solar panels of the array.

Under another aspect, a system for cleaning an array of solar panels is provided that includes a drive system movable along the array of solar panels; and a cleaning head coupled to the drive system so as to sequentially clean the solar panels as the drive system moves along the array. The cleaning head can include a fluid emitter configured to deposit fluid onto the solar panels; a wiper support structure including a first spring; and a wiper coupled to the cleaning head via the wiper support structure. The first spring can be configured to sequentially press the wiper downward against each of the solar panels so as to wipe the deposited fluid from those solar panels sequentially as the drive system moves along the array.

In some configurations, the wiper support structure further includes a second spring. The first spring optionally is configured to sequentially press a first end of the wiper against a first portion of each solar panel as the drive system moves along the array; and the second spring optionally is configured to sequentially press a second end of the wiper against a second portion of each solar panel as the drive system moves along the array. Optionally, a first solar panel is at a different angle than a second solar panel; and the first and second springs sequentially press the wiper into full respective contact with the first and second portions of each of the first and second solar panels. Additionally, or alternatively, a surface of at least one of the solar panels optionally includes a curvature; and the first and second springs press the wiper into full contact with the surface, including the curvature.

In some configurations, the wiper support structure further includes a damper configured to resist downward motion of the wiper. Optionally, the damper is configured to retard a swinging motion of the wiper at gaps between the solar panels as the drive system moves along the array.

In some configurations, the wiper support structure further includes a plurality of hinges configured to inhibit rotation of the wiper in a direction normal to the wiper. Optionally, the first spring is disposed within a first one of the hinges.

In some configurations, the wiper support structure further includes a frame structure and at least first and second links respectively coupling first and second ends of the wiper to the frame structure. Optionally, the first spring is disposed between the first and second links.

In some configurations, the wiper support structure further includes a bar and a rotary joint coupling the wiper to the bar. Optionally, the wiper support structure further includes a mounting structure, and the first spring is coupled to the bar and the mounting structure.

In some configurations, the cleaning head further includes a rotary brush configured to brush the fluid deposited onto the solar panels.

In some configurations, the solar panels are supported by a concrete track disposed on the ground, and wherein the drive system is in direct contact with the concrete track and drives along the concrete track.

Under yet another aspect, a method for cleaning an array of solar panels is provided that includes sequentially moving a cleaning head across the solar panels of the array; and depositing, by the cleaning head, fluid onto the solar panels. The method also can include, while sequentially moving the cleaning head across the solar panels of the array, sequentially pressing, by a first spring, a wiper of the cleaning head downward against respective solar panels so as to wipe the deposited fluid from those solar panels.

In some configurations, optionally the first spring sequentially presses a first end of the wiper against a first portion of each solar panel, and the method further includes sequentially pressing, by a second spring, a second end of the wiper against a second portion of each solar panel. Optionally, a first solar panel is at a different angle than a second solar panel; and the first and second springs sequentially press the wiper into full respective contact with the first and second portions of each of the first and second solar panels. Additionally, or alternatively, optionally a surface of at least one of the solar panels includes a curvature; and the first and second springs press the wiper into full contact with the surface, including the curvature.

In some configurations, the method includes resisting, by a damper, downward motion of the wiper. Optionally, the damper retards a swinging motion of the wiper at gaps between the solar panels as the cleaning head moves across the solar panels of the array.

In some configurations, the method includes inhibiting, by a plurality of hinges of the cleaning head, rotation of the wiper in a direction normal to the wiper. Optionally, the first spring is disposed within a first one of the hinges.

In some configurations, first and second ends of the wiper are coupled to a frame structure of the cleaning head via at least first and second links. Optionally, the first spring is disposed between the first and second links.

In some configurations, the wiper is coupled to a bar of the cleaning head via a rotary joint. Optionally, the first spring is coupled to the bar and to a mounting structure of the cleaning head.

In some configurations, the method includes brushing, by a rotary brush of the cleaning head, the fluid deposited onto the solar panels.

In some configurations, the solar panels are supported by a concrete track disposed on the ground, and the cleaning head is moved by a drive system in direct contact with the concrete track and drives along the concrete track.

Under still another aspect, a system for cleaning an array of solar panels is provided that includes a drive system movable along the array of solar panels; and a cleaning head coupled to the drive system so as to sequentially clean the solar panels as the drive system moves along the array. The cleaning head can include a fluid emitter configured to deposit fluid onto the solar panels; a wiper support structure including a first damper; and a wiper coupled to the cleaning head via the wiper support structure so as to sequentially wipe the deposited fluid from respective solar panels as the drive system moves along the array. The first damper can be configured to resist downward rotation of the wiper.

Under yet another aspect, a method for cleaning an array of solar panels is provided that includes sequentially moving a cleaning head across the solar panels of the array, and depositing, by the cleaning head, fluid onto the solar panels. The method also can include, while sequentially moving the cleaning head across the solar panels of the array, sequentially removing, by a wiper of the cleaning head, the deposited fluid from respective solar panels, and resisting, by a first damper, downward rotation of the wiper.

Under still another aspect, a system of cleaning a solar panel is provided. A surface of the solar panel can include a curvature. The system can include a cleaning head movable across the solar panel. The cleaning head can include a fluid emitter configured to deposit fluid onto the solar panel; a wiper support structure including first and second springs; and a wiper coupled to the first and second springs. The first and second springs can press the wiper into full contact with the surface, including the curvature, so as to wipe the deposited fluid from the solar panel as the cleaning head moves across the solar panel.

Under yet another aspect, a method for cleaning a solar panel is provided. A surface of the solar panel can include a curvature. The method can include moving a cleaning head across the solar panel, and depositing fluid onto the solar panel. The method also can include, while moving the cleaning head across the curved solar panel, sequentially pressing, by first and second springs, a wiper into full contact with the surface, including the curvature, so as to wipe the deposited fluid from the solar panel as the cleaning head moves across the solar panel.

### BRIEF DESCRIPTION OF DRAWINGS

FIG. 1 schematically illustrates an exemplary configuration of a cleaning system configured so as to clean an array of solar panels, according to some embodiments provided herein.

FIG. 2A schematically illustrates a perspective view of an exemplary configuration of the cleaning system of FIG. 1, according to some embodiments provided herein.

FIG. 2B schematically illustrates a side view of the cleaning system of FIG. 1 with housing components around the drive system removed for clarity, according to some embodiments provided herein.

FIG. 3 schematically illustrates a side view of an exemplary configuration of a cleaning head such as can be included within the cleaning system illustrated in FIG. 1, according to some embodiments provided herein.

FIG. 4 schematically illustrates a perspective view of the underside of an exemplary configuration of the cleaning head of FIG. 3, according to some embodiments provided herein.

FIG. 5 schematically illustrates a flow of operations in an exemplary method of cleaning a solar panel, according to some embodiments provided herein.

FIG. 6 schematically illustrates a side view the cleaning head of FIG. 3 in a dry-cleaning mode, according to some embodiments provided herein.

FIG. 7 schematically illustrates a flow of operations in an exemplary method of cleaning an array of solar panels without the use of cleaning fluid, and in which the brush but not the wiper is lowered, according to some embodiments provided herein.

FIGS. 8A and 8B schematically illustrate additional perspective views of the cleaning system of FIG. 1 including the cleaning head of FIG. 3, according to some embodiments provided herein.

FIGS. 9A and 9B schematically illustrate additional perspective views of the cleaning system of FIG. 1 including the cleaning head of FIG. 3, according to some embodiments provided herein.

FIG. 10 schematically illustrates a perspective view of an alternative cleaning head, according to some embodiments provided herein.

FIG. 11A schematically illustrates the cleaning head configuration of FIG. 10 with the wiper retracted, according to some embodiments provided herein.

FIG. 11B schematically illustrates the cleaning head configuration of FIG. 10 with the wiper in a fully downward position, according to some embodiments provided herein.

FIG. 12 schematically illustrates an alternative configuration of part of the cleaning head of FIG. 2, according to some embodiments provided herein.

### DETAILED DESCRIPTION

Provided herein are systems and methods for cleaning arrays of solar panels, e.g., solar photovoltaic panels.

For example, one consideration in the construction of solar power plants is reducing capital cost as much as possible. One strategy to keep construction costs down is to build the plant in such a way that relatively large tolerances are acceptable for the various measured distances and angles between power plant elements. As a result, an array (e.g., row) of solar panels may not necessarily be very straight. Some panels may be a little higher than others or a little further in one horizontal direction than others. The surfaces of different panels may be at slightly different angles. Gaps between panels in an array can vary as well. From a power output point of view, such variations can be acceptable since the panel power output is insensitive to such positional and angular variations.

As provided herein, a cleaning system can drive along and consistently clean foreign matter from an array of solar panels and can function properly even when the solar panels of the array are not perfectly aligned with one another. The cleaning system is specially designed so as to accommodate minor variations in solar panel position, orientation, and flatness. Additionally, the cleaning system can accommodate variations in drag force. However, it should be appreciated that the cleaning system also can be used to clean solar panels that are perfectly or substantially aligned and oriented relative to one another, are flat, and/or have no variations in drag force.

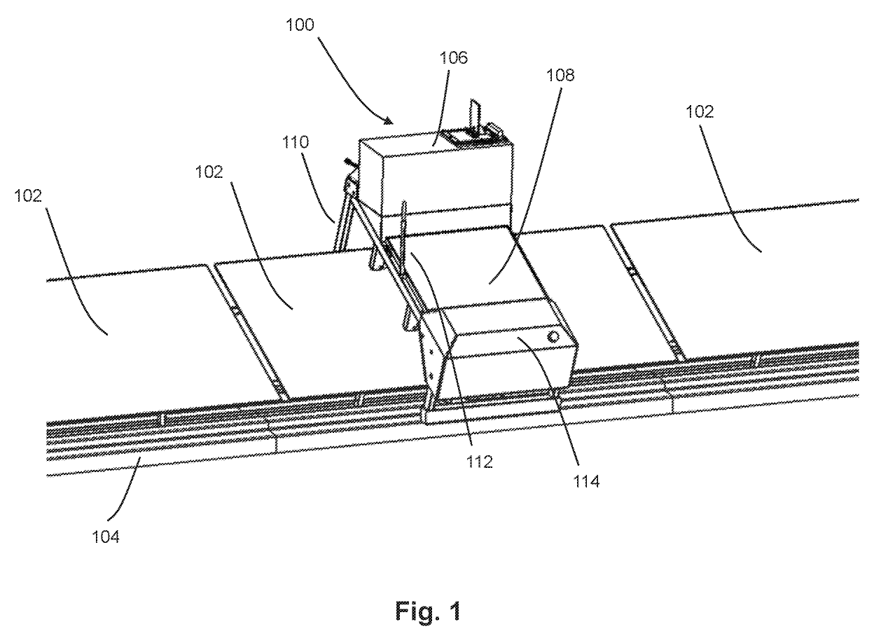

For example, FIG. 1 schematically illustrates an exemplary configuration of cleaning system 100 configured so as to clean an array of solar panels 102, e.g. a row of solar photovoltaic panels, that is disposed on and along elongated track 104, according to some embodiments provided herein. Optionally, at least some of the solar panels can have different positions, orientations, drag forces, and/or flatness than one another. The track 104 can include any suitable material or combination of materials, e.g., can be or can include paved concrete, asphalt concrete, metal rails, wood, piping, or another suitable type of track. A solar plant can include one or many rows or arrays of solar panels 102, each of which arrays can be disposed along one or more corresponding elongated tracks 104, and each of which can include any suitable number of solar panels, e.g., can be a few panels long or even up to 1000 panels or more long. In one configuration, the track 104 extends past the ends of the array of solar panels 102.

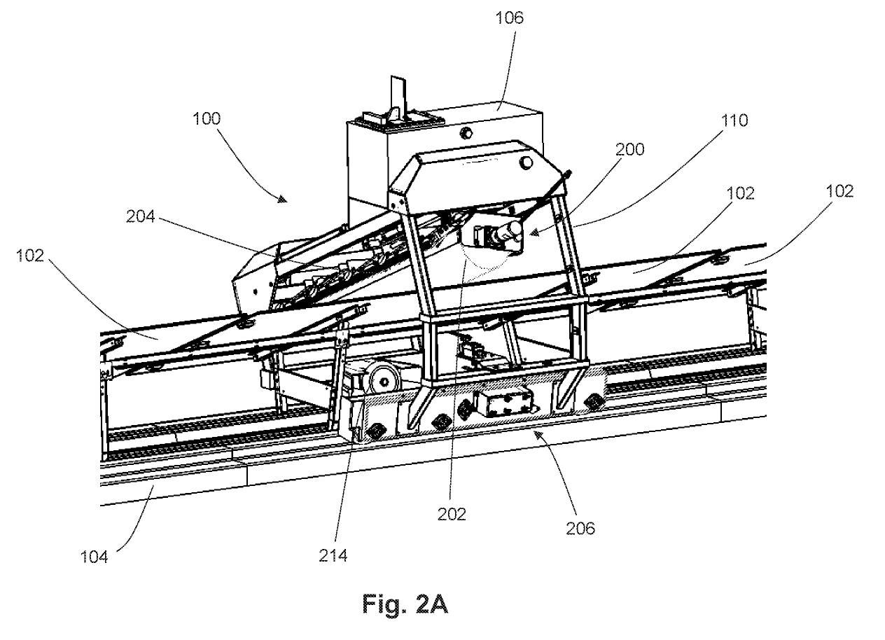

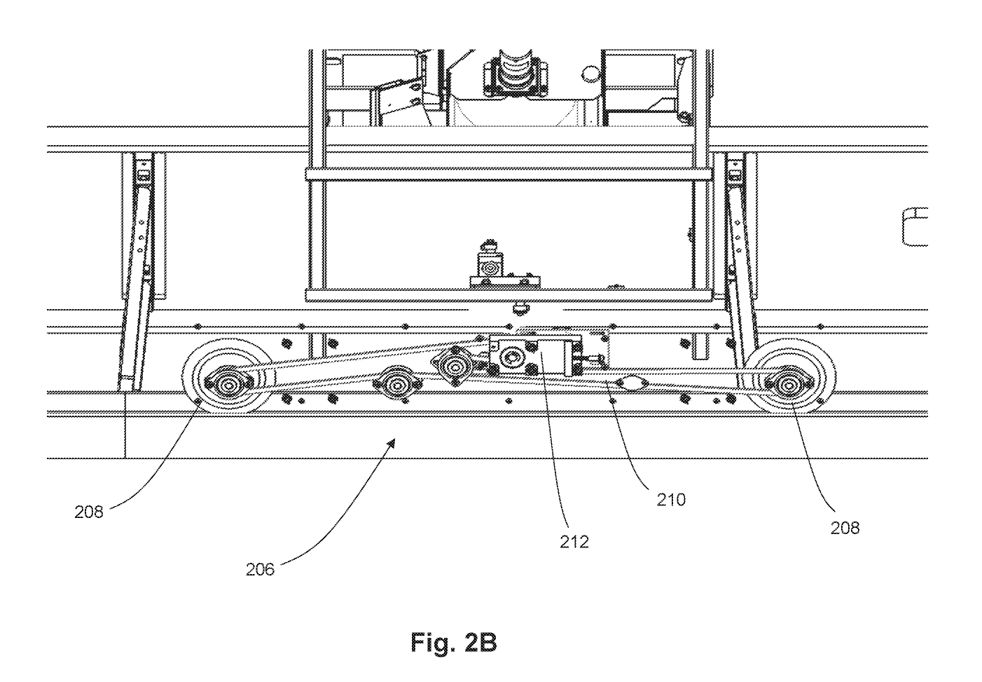

Cleaning system 100 can be configured so as to drive along on the track 104 and clean the array of solar panels 102. For example, cleaning system 100 can include a drive system movable along the array of solar panels, such as described with reference to FIG. 2A. Cleaning system 100 can include wheels, caterpillar treads, or other structure allowing cleaning system 100 to drive along track 104 responsive to actuation of the drive system. Cleaning system 100 also can include a cleaning fluid reservoir 106, e.g., water tank, that carries water or other fluid for cleaning the array of solar panels 102. Cleaning system 100 also can include solar panel 108 mounted thereon or coupled thereto for power. Cleaning system 100 also can include support structure 110 configured so as to provide support for one or more elements of cleaning system 100, e.g., one or more elements of a cleaning head such as described in greater detail herein. Cleaning system 100 also can include radio communications circuitry and an antenna 112 configured to transmit and receive radio signals to and from a remote computer control system (not specifically illustrated). The radio communication system can be used for the remote computer control system to direct the cleaning machine to do a variety of operations including but not limited to any suitable combination of starting, stopping, cleaning, moving to a new position without cleaning, and changing cleaning mode. The radio communication system can also be used to transmit the cleaning system's status back to the remote computer control system or an operator thereof. Such status can include, but is not limited to, any suitable combination of the cleaning system's location, direction, speed, cleaning mode, level of cleaning fluid, battery state of charge, charging rate, power draw, or other status metrics. Cleaning system 100 also can include housing 114 configured so as to cover and protect electronics and batteries such as may be used to control or power the cleaning system (not specifically illustrated). In one nonlimiting example, track 104 can include a concrete track disposed on the ground that supports the solar panels of the array, and the cleaning head is moved by a drive system in direct contact with the concrete track and that drives along the track.

FIG. 2A schematically illustrates a perspective view of an exemplary configuration of cleaning system 100 of FIG. 1, according to some embodiments provided herein. As illustrated in FIG. 2A, support structure 110 of cleaning system 100 supports cleaning head 200, which includes rotating brush 202 and wiper 204. Brush 202 can be or include any suitable rotatable structure for removing physical debris (such as inorganic dust, soil particles, guano, or particulate matter from combustion) from solar panels and/or to brush fluid deposited onto the solar panels, such as a bristled brush, a cloth brush, or another type of brush. Wiper or squeegee 204 can be made of or can include a soft, compliant material such as rubber. In one optional configuration, brush 202 and wiper 204 can be wider than the width of the solar panels being cleaned. Cleaning head 200 can be configured so as to hang from support structure 110. Cleaning system 100 can include drive system 206, which in one optional configuration can be located on the bottom of the system 100 near the track 104.

FIG. 2B schematically illustrates a side view of the cleaning system 100 with housing components around the drive system removed for clarity, according to some embodiments provided herein. In the nonlimiting configuration illustrated in FIG. 2B, drive system 206 can include any suitable number of wheels 208, e.g., two wheels or more than two wheels, a chain drive system 210, and a geared motor 212 that drives one or more of the wheels via the chain drive system. Alternatively, drive system 206 can include one or more motors accompanied by gear boxes configured to directly drive one or more wheels without a chain drive system. In various exemplary configurations, drive system 206 can include and be powered by a combustion engine and transmission. As still another alternative, cleaning system 100 can be pushed or pulled by an external vehicle, a person, or other means. In one configuration, a third wheel 214 is located on the other side of the track relative to wheels 208 and helps support the system and guide its movement along the track. Any suitable number of wheels, e.g., a set of two wheels, can be used in place of the third wheel 214. Only one or all wheels can be driving wheels. That is, not all of the wheels necessarily need to be powered by drive system 206. One or more of wheels 208, and optionally all of wheels 208, can be in contact with and drive along surface(s) of the same track(s) that support the solar panels of the array.

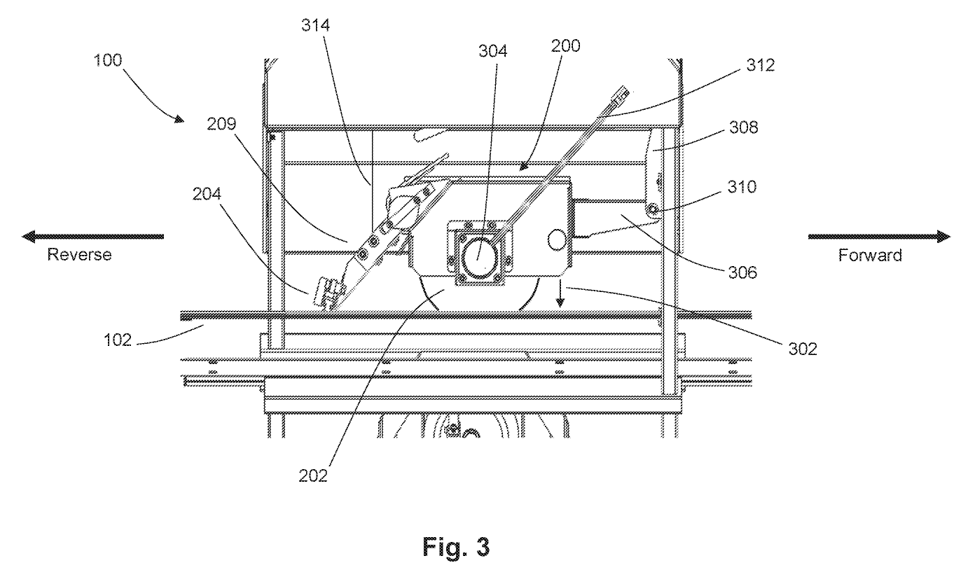

FIG. 3 schematically illustrates a side view of an exemplary configuration of cleaning head 200, according to some embodiments provided herein. Cleaning head 200 can be coupled to drive system 206 and configured to sequentially clean the solar panels as the drive system moves along the array. The rotating brush 202 and wiper 204 of cleaning head 200 are shown, and an arrow 302 denotes where the cleaning head 200 deposits a cleaning fluid such as water on the solar panels 102, e.g., using a fluid emitter. Brush 202 can be rotated by a motor 304 with a power cable 312 shown connected to it. Cleaning head 200 can include any suitable number of arms 306, e.g., two arms, which are attached to a structural member 308 of the cleaning system by a pivot point 310. The cleaning head 200 can rotate down to engage with the solar panels 102 or can rotate up so that cleaning system 100 can travel along the array of panels without the cleaning head 200 engaging with the solar panels 102. In some embodiments, brush 202 and wiper 204 can be raised and lowered sequentially by a cable 314. In one optional configuration, when brush 202 and wiper 204 are lowered, the brush lowers first and then hits a hard stop at which the brush contacts solar panels 102. Then as the cable 314 is further extended, wiper 204 is lowered into contact with solar panels 203. The cable 314 can be actuated by a linear actuator, by a motor, by a pneumatic system, by hand, or by a variety of other ways. In one nonlimiting example, when cleaning system 100 moves toward the right of FIG. 3 it can be considered to be going forward, and moving toward the left of FIG. 3 it can be considered to be going in reverse.

In certain configurations provided herein, cleaning head 200 includes a wiper support structure 209 and any suitable number of mechanical linkages 207 that are spaced apart from one another. The mechanical linkages 207 can couple respective portions of the wiper 204 to wiper support structure 209 partially independently of one another. For example, respective portions of the wiper 204 can move at least partially independently of one another in a direction along a respective axis, such that movement of one portion of the wiper in that direction does not cause an identical movement of another portion of the wiper in that direction. Additionally, or alternatively, the mechanical linkages 207 can couple respective portions of the wiper 204 to wiper support structure 209 partially independently of the wiper support structure. For example, respective portions of the wiper 204 can move at least partially independently of the wiper support structure 209 in a direction along a respective axis, such that movement of one portion of the wiper in that direction does not cause an identical movement of the wiper support structure 209 in that direction. Such independent movement of the wiper portions relative to one another and to the wiper support structure 209 allow the wiper to fully or substantially fully contact the surface of each solar panel of the array, even though such surfaces optionally can have different positions, orientations, drag forces, or flatness than one another.

For example, if a solar panel is higher on a first side and lower on a second side than other solar panels of the array (orientation variation), the portion of the wiper 204 over the first side can move upward via the corresponding mechanical linkage 207 and the portion of the wiper 204 over the second side can move downward via the corresponding mechanical linkage 207, allowing the wiper to maintain full or substantially full contact with that solar panel while the wiper support structure 209 maintains a constant position within cleaning head 200. Or, for example, if a solar panel is horizontally shifted relative to other solar panels of the array (position variation), the portion of the wiper 204 over one side of the panel can shift downwards via the corresponding mechanical linkage 207 and the portion of the wiper 204 over another side can move upwards via the corresponding mechanical linkage 207, allowing the wiper to maintain full or substantially full contact with that solar panel while the wiper support structure 209 maintains a constant position within cleaning head 200. Or, for example, if the surface of a solar panel has a curvature (flatness variation) such as can occur with frameless solar panels, the portion of the wiper 204 over one side of the panel can shift downwards via the corresponding mechanical linkage 207 and the portion of the wiper 204 over another side also can move downwards via the corresponding mechanical linkage 207, allowing the wiper to maintain full or substantially full contact with that solar panel while the wiper support structure 209 maintains a constant position within cleaning head 200. Or, for example, if the surface of a solar panel has a portion with higher drag force (drag force variation), the portion of the wiper 204 over the portion of the panel with higher drag force can shift upwards via the corresponding mechanical linkage 207 so as to reduce the drag force, allowing the wiper to maintain full or substantially full contact with that solar panel while the wiper support structure 209 maintains a constant position within cleaning head 200.

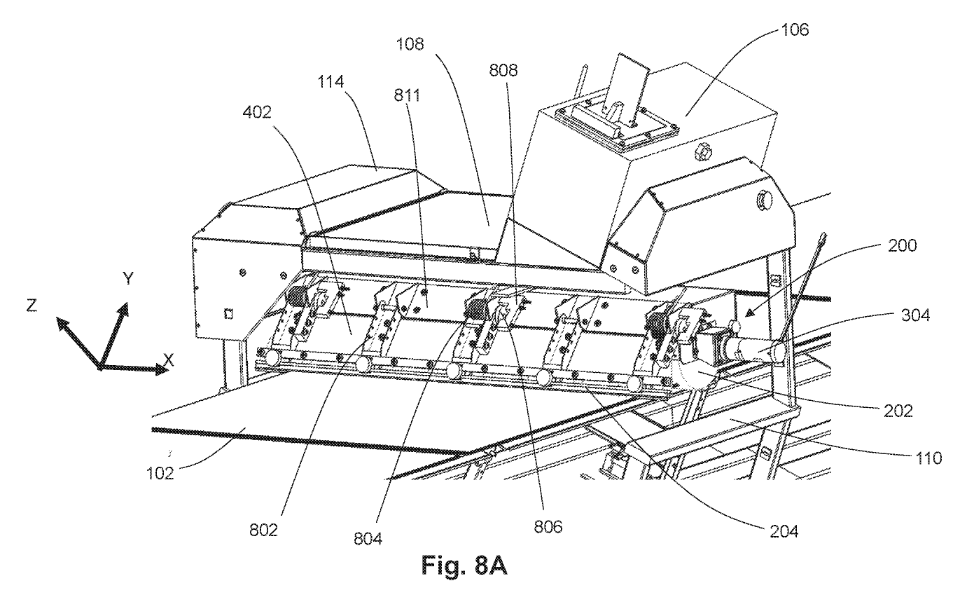

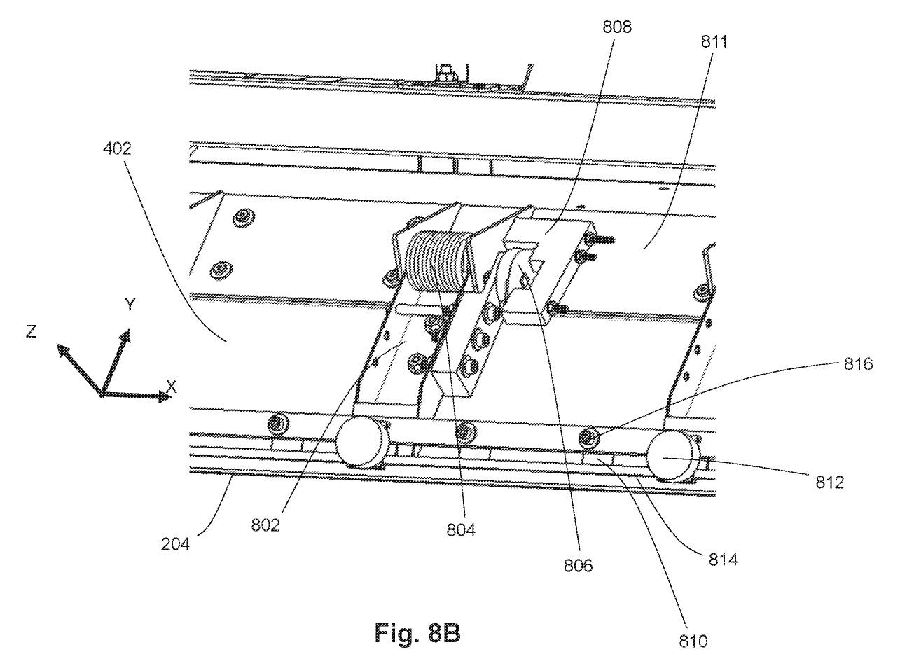

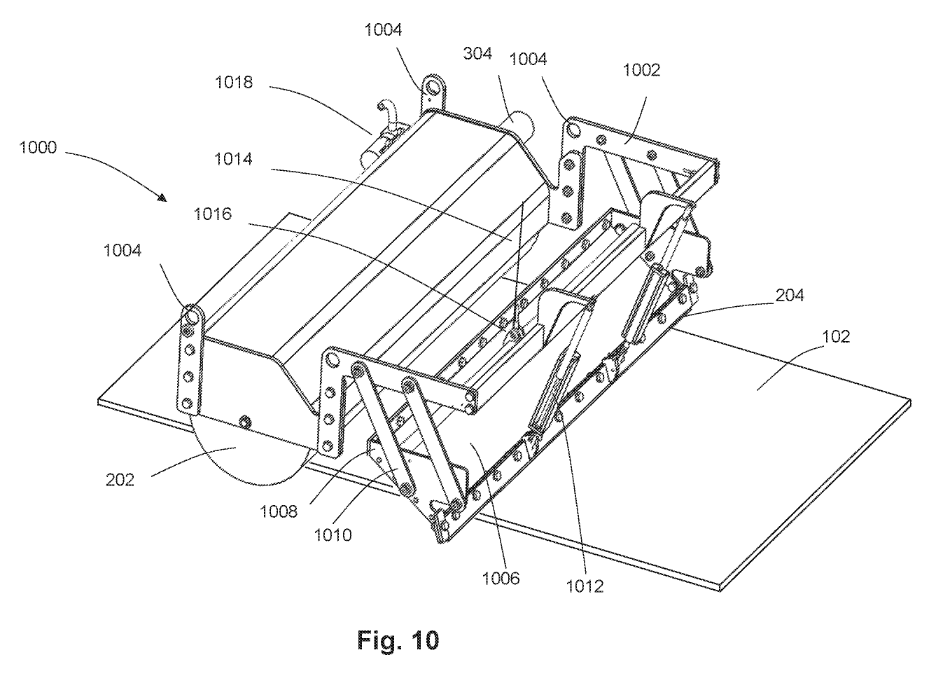

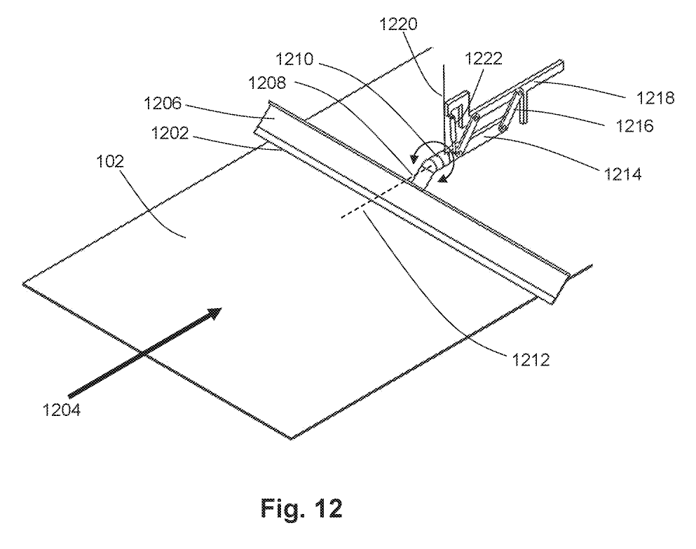

Exemplary configurations of such mechanical linkages 207 suitable for use in cleaning system 100 and cleaning head 200 are provided with reference to FIGS. 8A-8A and 10. Other suitable mechanical linkages can be used to couple respective portions of wiper 204 to wiper support structure 209. FIG. 12 illustrates another example mechanical linkage suitable for use in cleaning system 100 and cleaning head 200. Optionally, cleaning head 200 can include one or more dampers configured to retard downward movement of wiper 204, e.g., within gaps between solar panels. Additionally, or alternatively, cleaning head 200 can include one or more springs configured to press wiper 204 downward against the solar panel.

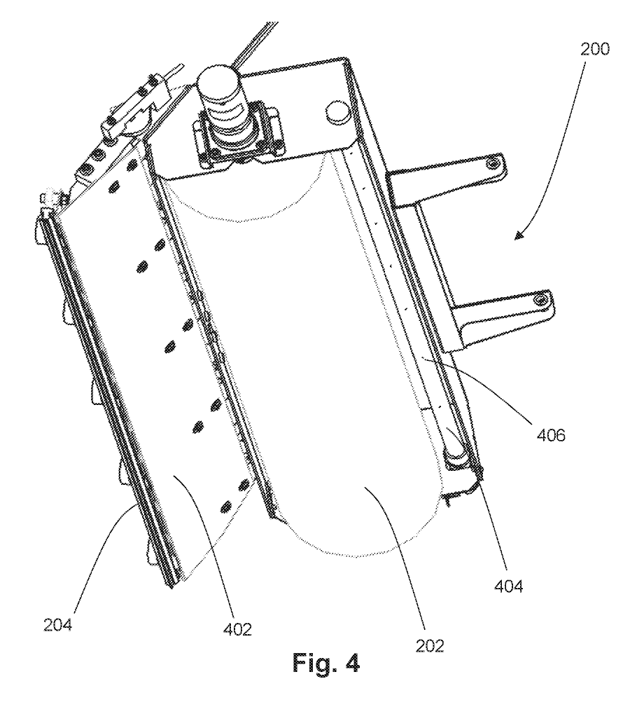

FIG. 4 schematically illustrates a perspective view of the underside of an exemplary configuration of cleaning head 200, according to some embodiments provided herein. Wiper 204 can be mounted on a wiper plate 402. Cleaning head 200 can include cleaning fluid emitter 404, e.g., a water emitter, which optionally can be located in front of brush 202. Cleaning fluid emitter 404 can include one hole or a plurality of holes 406 through which a cleaning fluid, such as water, exits the emitter and falls, squirts, or sprays onto the solar panels 102.

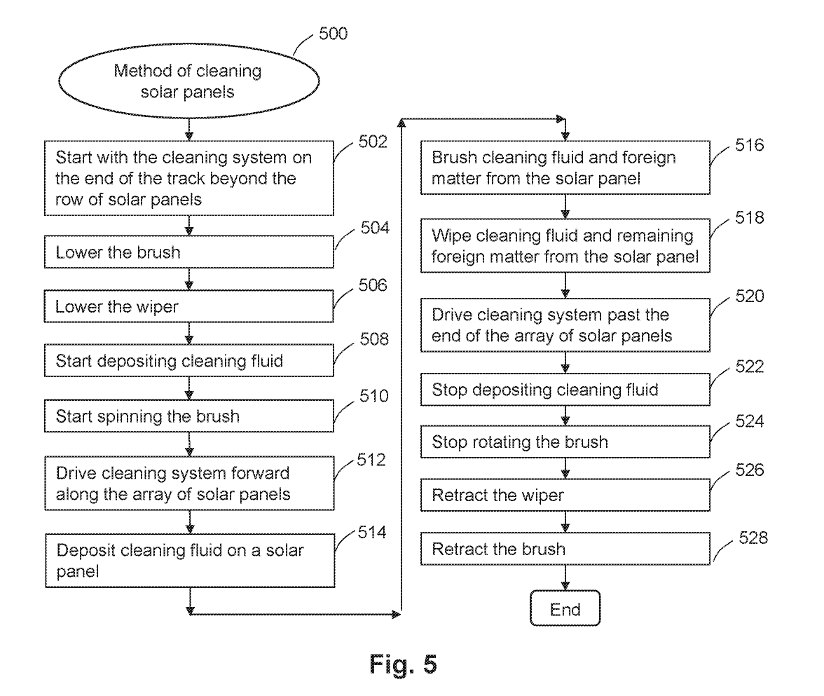

FIG. 5 schematically illustrates a flow of operations in an exemplary method 500 of cleaning a solar panel, according to some embodiments provided herein. Method 500 can include starting with the cleaning system on the end of the track beyond the array of solar panels (502). For example, cleaning system 100 illustrated in FIGS. 1-4 can start on an end of track 104 beyond the array of solar panels 102. Method 500 also can include lowering the brush (504) and lowering the wiper (506). For example, cleaning brush 202 and wiper 204 can be lowered to a position where they will engage with the solar panels 102. Method 500 also can include starting depositing cleaning fluid (508), such as water, and start spinning the brush (510). For example, cleaning system 100 can begin depositing cleaning fluid onto the array of solar panels 102 via cleaning fluid emitter 404 and can begin spinning brush 202. Method 500 also can include driving the cleaning system forward along the array of solar panels (512). For example, cleaning system 100 can begin moving forward toward and along the array of solar panels 102 responsive to actuation of drive system 206. Method 500 also can include depositing cleaning fluid onto a solar panel (514). For example, when passing over a given section of a given solar panel of the array of solar panels 102, cleaning system 100 can deposit cleaning fluid (such as water) onto that solar panel, e.g., via cleaning fluid emitter 404. The cleaning fluid, e.g., water, can act to reduce any adhesion between foreign matter (e.g., soiling particles) and the solar panel surface and/or so as to entrain the foreign matter (e.g., soiling particles). Method 500 can include brushing cleaning fluid and foreign matter from the solar panel (step 516). For example, rotating brush 202 can push foreign matter, e.g., soiling particles, and the cleaning fluid, e.g., water, from the surface of the solar panel of array 102. Method 500 also can include wiping the cleaning fluid and foreign matter from the solar panel (step 518). For example, wiper 204 can push any remaining cleaning fluid, e.g., water, with any foreign matter entrained therein, off the edge of the solar panel of array 102. Method 500 also can include the cleaning system driving past the end of the array of panels (520), stopping the deposition of cleaning fluid (522), stopping the rotation of the brush (524), retracting the wiper (526), and retracting the brush (528). For example, when cleaning system 100 drives past the last solar panel in the array 102, the cleaning head stops depositing cleaning fluid (e.g., cleaning fluid emitter 404 stops depositing cleaning fluid), and brush 202 stops rotating. The cleaning brush 202 and wiper 204 can be retracted to their higher positions.

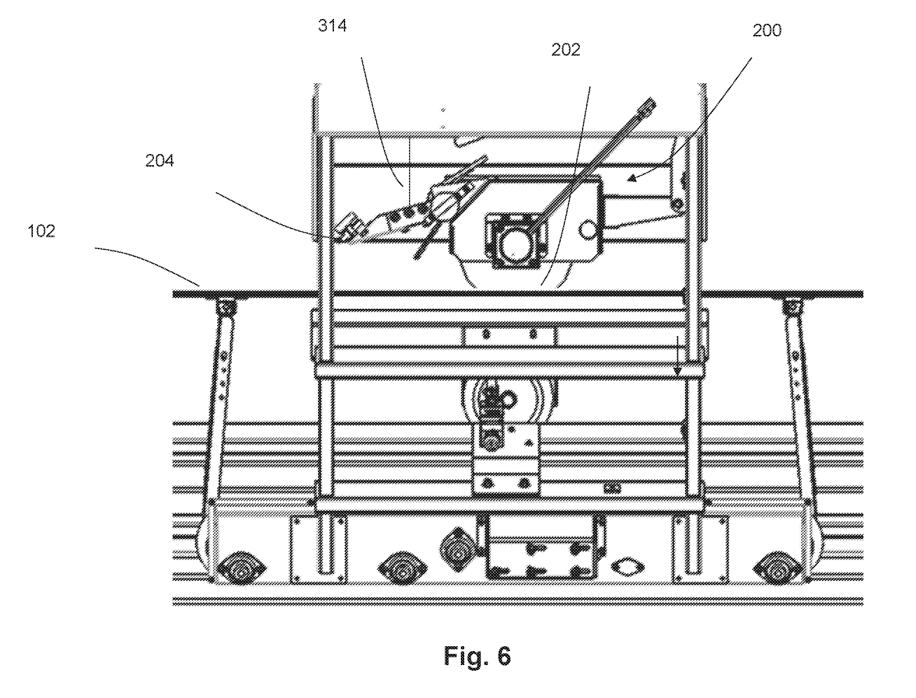

FIG. 6 schematically illustrates a side view of the cleaning head of FIG. 3 in an alternative mode of operation in which cleaning system 100 can be used in a dry-cleaning mode, according to some embodiments provided herein. In this position, the rotating brush 202 is engaged with the array of solar panels 102, but the wiper 204 is retracted by the cable 314. No cleaning fluid is deposited on the solar panels.

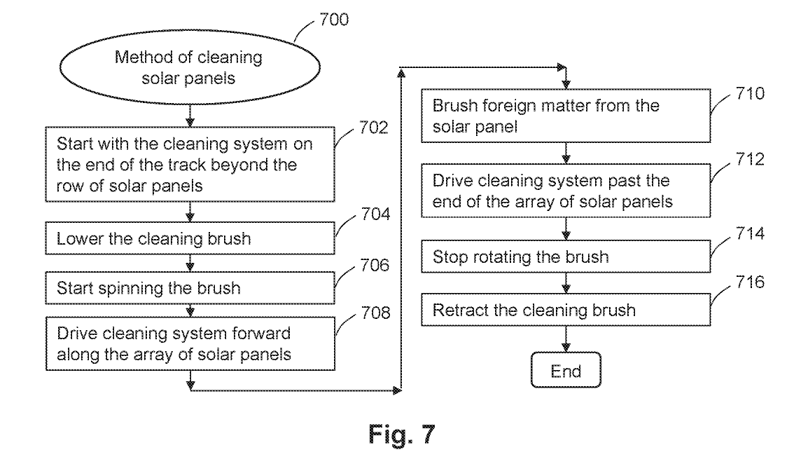

FIG. 7 schematically illustrates a flow of operations in an exemplary method 700 of cleaning an array of solar panels without the use of cleaning fluid, and in which the brush but not the wiper is lowered, according to some embodiments provided herein. The spinning of the brush alone can be used to remove foreign matter. This method may be appropriate for certain types of soiling and/or for circumstances in which a cleaning fluid is not available or not appropriate for use. Method 700 can include starting with the cleaning system on the end of the track beyond the array of solar panels (702) in similar manner as operation 502 described above with reference to FIG. 5. Method 700 also can include lowering the cleaning brush (704), in similar manner as operation 504 described above with reference to FIG. 5. Method 700 also can include starting spinning of the brush (706), in similar manner as operation 510 described above with reference to FIG. 5. Method 700 also can include driving the cleaning system forward along the array of solar panels (708), in similar manner as operation 512 described above with reference to FIG. 5. Method 700 also can include brushing foreign matter from the solar panel (710), in similar manner as operation 516 described above with reference to FIG. 5, except that no cleaning fluid is used during step 710. Method 700 also can include driving the cleaning system past the end of the array of solar panels (712), in similar manner as operation 520 described above with reference to FIG. 5. Method 700 also can include stopping rotation of the brush (714), in similar manner as operation 527 described above with reference to FIG. 5. Method 700 also can include retracting the cleaning brush (716), in similar manner as operation 528 described above with reference to FIG. 5.

It should be appreciated that method 500 illustrated in FIG. 5 and method 700 illustrated in FIG. 7 can be implemented using any suitable cleaning system, including but not limited to cleaning system 100 and any suitable variations thereof such as described herein with reference to FIGS. 1-4, 6, 8A-8B, 9A-9B, and 10-12.

FIGS. 8A and 8B schematically illustrate additional perspective views of the cleaning system of FIG. 1 including the cleaning head of FIG. 3, according to some embodiments provided herein. More specifically, FIGS. 8A and 8B schematically illustrate a perspective view of one exemplary configuration of the back side of the wiper 204 and how the wiper can be held by support structure 110. Some structural elements of the cleaning system 100 are omitted from FIGS. 8A-8B for clarity. FIG. 8B is a zoomed-in view of FIG. 8A. In the configuration illustrated in FIGS. 8A-8B, wiper 204 can be mounted on wiper plate 402. For example, a wiper mount 810 can include a series of fasteners 812 and a bar 814 to hold the wiper 204 against wiper mount 810, and then another series of fasteners 816 can secure the wiper mount 810 to the wiper plate 402. For reference, X,Y,Z coordinate axes are shown where Z is normal to wiper plate 402, and X is aligned with wiper 204. Optionally, wiper 204 and wiper plate 402 together are relatively flexible along the length of the wiper 204 so as to allow bending about an axis parallel to the Y axis. Such flexibility can help to provide full or substantially full contact of wiper 204 with the solar panels of array 102, accommodating for slight curvature in the solar panel surface. The assembly of wiper 204 and wiper plate 402 can be relatively lightweight as well so as to help the wiper conform to the surfaces of the solar panels.

In some configurations, the wiper plate 402 can be held onto a wiper support structure 811 of the cleaning head 200 by a series of mechanical linkages, such as hinges 802, which are spaced apart from one another. Wiper support structure 811 can be considered to include the mechanical linkages, or the mechanical linkages can be considered to be a separate component from wiper support structure 811. Five mechanical linkages, e.g., hinges 802, are shown in the nonlimiting configuration of FIG. 8A, but any suitable number of mechanical linkages such as hinges, e.g., more or fewer than five linkages (e.g., hinges), can be used. Mechanical linkages, e.g., hinges 802, can be arranged such that wiper plate 402 and wiper 204 are pushed against the solar panels and moved in the direction of travel from both ends, and optionally also can be pushed against the solar panels and moved in the direction of travel from the center in addition to from the sides. The structures of the mechanical linkages, e.g., hinges 802, and wiper plate 402 can be arranged so as to constrain, prevent, or inhibit any rotation of the wiper plate and wiper about an axis, such as the Z axis. Hinges 802 also can provide stiffness to wiper plate 402 in the Y direction and can prevent or inhibit any bending of wiper plate 402 about an axis parallel to the X direction. Alternatively, stiffeners that are separate from the hinges can be used to provide stiffness in the Y direction. Hinges 802 also can allow partially independent motion of different portions of the wiper 204 relative to one another, e.g., about a first axis, such as the X axis, and also relative to wiper support structure 811 along a second axis, which may be the same as the first axis or may be a different axis. For example, the hinges can be rotatable about the first axis.

In some configurations, some of hinges 802 include torsional springs 804 that can act to press wiper 204 against the array of solar panels 102 with sufficient force as to wipe cleaning fluid and foreign matter from the panels. Three springs 804 are shown in the nonlimiting configuration of FIG. 8A, but any suitable number of springs, e.g., one or two springs, or more than three springs, can be used. Optionally, a damper, such as rotary dashpot 806, is mounted on some or all of hinges 802 and can be secured by a respective mounting bracket 808. Dampers, such as rotary dashpots 806, can retard a swinging motion of wiper 204 when the wiper transitions from one solar panel to another.

Continuing with FIGS. 8A and 8B, in some configurations wiper 204 never or substantially never inadvertently lifts off of a solar panel while it is cleaning that solar panel, even though drag forces can be uneven along the length of wiper 204. For example, an imbalance of drag forces can lead to rotation of a wiper about an axis parallel to the Z direction in the illustrated coordinate axes, which can cause the wiper to lift from the solar panel and to skip and stutter along, causing cleaning performance to be degraded. Such degradation can happen if the degrees of freedom of the wiper are not properly constrained. Cleaning system 100 can be configured so as to reduce, inhibit, or avoid these problems and can be designed so as to passively rebalance drag forces along wiper 204 when any imbalances arise. For example, in the configuration illustrated in FIGS. 8A-8B, based upon drag forces being higher on one end of wiper 204 than on the other end, independent mechanical linkages, e.g., hinges 802, can act to keep each section of wiper 204 in contact with the solar panel. Or, for example, based upon a section of wiper 204 experiencing drag forces higher than the average drag forces across the wiper, the nearest mechanical linkage, e.g., hinge 802, to that section can allow the wiper to rotate backward and upward together. The upward motion can reduce the normal force between wiper 204 and the solar panel thereby reducing local drag forces.

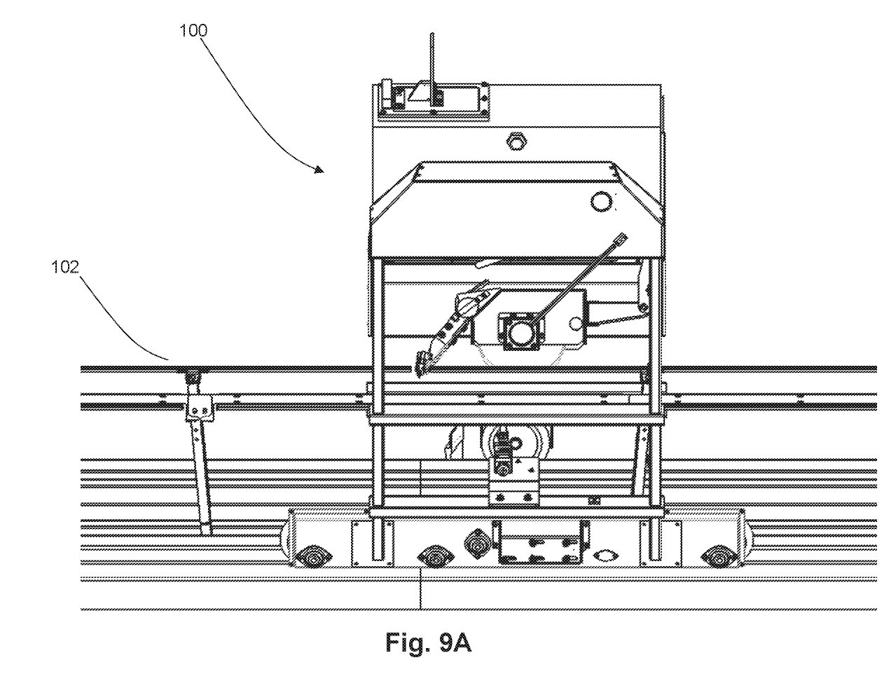

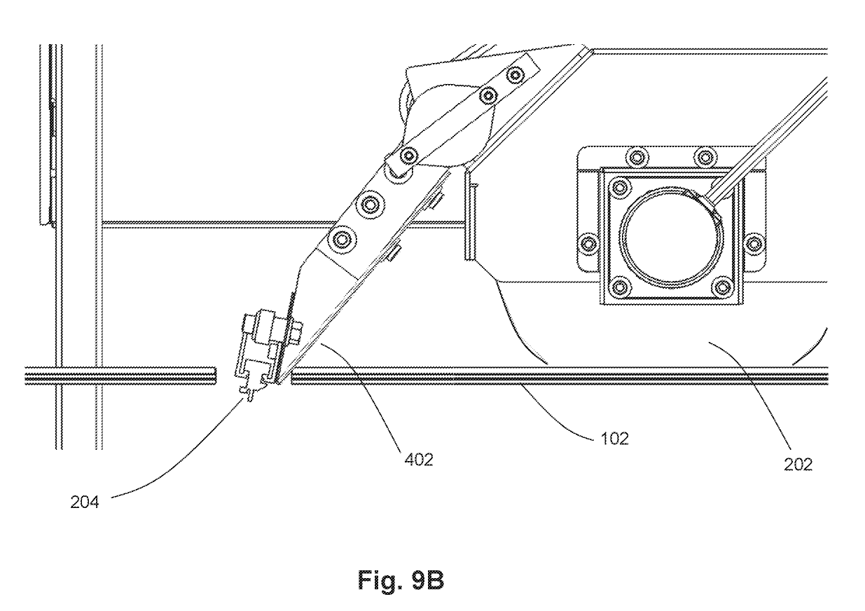

FIGS. 9A and 9B schematically illustrate additional perspective views of the cleaning system of FIG. 1 including the cleaning head of FIG. 3, according to some embodiments provided herein. More specifically, FIGS. 9A and 9B schematically illustrate a configuration of cleaning system 100 at a position where the cleaning system is moving between one solar panel and another of the array 102. FIG. 9B is a zoomed-in view of FIG. 9A. In a solar power plant, there may be gaps between the solar panels in an array 102. Additionally, or alternatively, because of variations in construction tolerances, the panels may be at slightly different heights or transverse positions relative to one another. Cleaning system 100 can be configured so as to move smoothly between one panel and another, even when gaps between solar panels of the array are significant. For example, brush 202 can have bristles or wipers that are flexible enough that they impart a negligible force upon contact with edge of a solar panel. The brush 202 also can have long bristles or cloth wipers so that brush 202 can accept significant variations in the relative positions of the solar panels. Additionally, or alternatively, wiper 204 can be pressed against the solar panels 102 by springs, such as torsion springs 804, such that when wiper 204 transitions from one panel to the next, the springs can press the wiper into the gap between the panels. Additionally, or alternatively, dampers, such as rotary dashpots 806, such as shown in FIG. 8A-8B, can act to retard any swinging motion of wiper 204 when the wiper moves past the end of a solar panel 102 and into a gap between that panel and the next panel. Dampers, such as rotary dashpots, rotary limiters, or rotary dampers, can help to provide gentle contact between wiper plate 402 and the next solar panel and can inhibit hard interactions of between the wiper plate and that solar panel. Additionally, or alternatively, as cleaning system 100 moves from a first panel to a second panel, and wiper plate 402 contacts the edge of the second panel, this panel can act as a sliding contact bearing and can guide wiper 204 into position to clean the top of the panel 102. Because the wiper 204 and wiper plate 402 are relatively lightweight, they do not develop significant momentum that would be converted to a detrimental force on the solar panel.

FIG. 10 schematically illustrates a perspective view of an alternative cleaning head 1000, according to some embodiments provided herein. Cleaning head 1000 can be used in cleaning system 100 and configured for cleaning fluid deposition and can include rotating brush 202 and wiper 204 in similar manner as in the configuration of FIGS. 1-9B. However, the cleaning implements can be mounted differently in cleaning head 1000 as compared to in cleaning head 200. For example, cleaning head 1000 can include a frame structure 1002 that hangs from cleaning system 100 via any suitable number of links in a linkage system (not shown), e.g., four links in a four-bar linkage system, that respectively connect to mounting points 1004. For example, a first mechanical linkage can include first and second links 1010 coupling a first portion of wiper 204 to a wiper support structure, e.g., frame structure 1002, and a second mechanical linkage can include third and fourth links 1010 coupling a second portion of wiper 204 to frame structure 1002. Rotating brush 202 and associated drive motor 304 can be mounted into or otherwise coupled to frame structure 1002. Wiper 204 and associated wiper plate 1006 can be mounted on wiper assembly frame 1008. Wiper plate 1006 can be configured so as to support wiper 204 and aid in transitioning from one solar panel to the next one, similar to the wiper plate 402 in FIG. 4. Wiper frame 1008 can be attached to any suitable number of links 1010, e.g., two links on each side of wiper 204, which links can be attached to the frame structure 1002. In the nonlimiting configuration illustrated in FIG. 10, two links 1010, the wiper frame 1008, and the frame structure 1002 together form a four-bar linkage which allows wiper 204 to swing up and down while preserving the wiper angle with respect to the plane of solar panel 102, e.g., coupling first and second portions of wiper 204 to frame structure 1002 partially independently of one another and partially independently of frame structure 1002 such that wiper 204 sequentially fully contacts each of the solar panel surfaces to wipe deposited fluid from those surfaces as the drive system moves along the array. Optionally, at least some of the solar panels can have different positions, orientations, drag forces, or flatness than one another.

When wiper 204 is in contact with a solar panel, linear spring-damper elements 1012 can act both to apply force between the wiper and the solar panel and also to retard the swinging motion of the wiper to prevent the accumulation of momentum. In such a manner, wiper 204 and wiper plate 1006 may contact a solar panel relatively gently when first contacting that panel. The spring-damper elements 1012 can also or alternatively be or include any suitable number of separate compression springs and/or dampers. The dampers can be or include dash pots, gas springs, or other elements that retard motion. The wiper 204 and its assembly can be raised or lowered to be in contact with solar panels with the use of a cable 1014, which can be attached onto the wiper frame 1008 at an attachment point 1016. The cleaning fluid emitter, not shown, can be fed with cleaning fluid (such as water) by a cleaning fluid pump 1018. Additionally, or alternatively, the cleaning fluid emitter can be gravity-fed and/or limited by a valve.

As mentioned earlier, uneven drag forces along a wiper can result in the wiper partially lifting off of the solar panel. The configuration in FIG. 10 can inhibit wiper 204 from inadvertently lifting off the solar panel because of the arrangement of the links 1010, wiper plate 1006, and spring-dampers 1012. For example, based upon there being an imbalance in drag forces along wiper 204, the links 1010 on the side with higher drag can facilitate the wiper 204 to move backward relative to the other side of the wiper, and the links 1010 can also guide the side with the higher drag slightly up and away from the solar panel. Such actions of the links can reduce the normal force between wiper 204 and the solar panel, which can reduce drag forces locally. Optionally, the tolerances at the attachment points of the links 1010 can be relatively loose so that one set of links 1010 can slightly rotate independently of the other set of links 1010. Additionally, or alternatively, links 1010 can be spaced relatively wide apart from one another and on the ends of the wiper so as to inhibit or prevent movement of either end of wiper plate 1006 and wiper 204 along the direction of the links. As such, the resulting assembly can passively act to reduce higher drag and even out uneven drag forces across wiper 204. Because the links 1010 on one side can move at least partially independently from the links on the other side, the wiper 204 can also adapt to variations in the angle, flatness, or orientation of the solar panels.

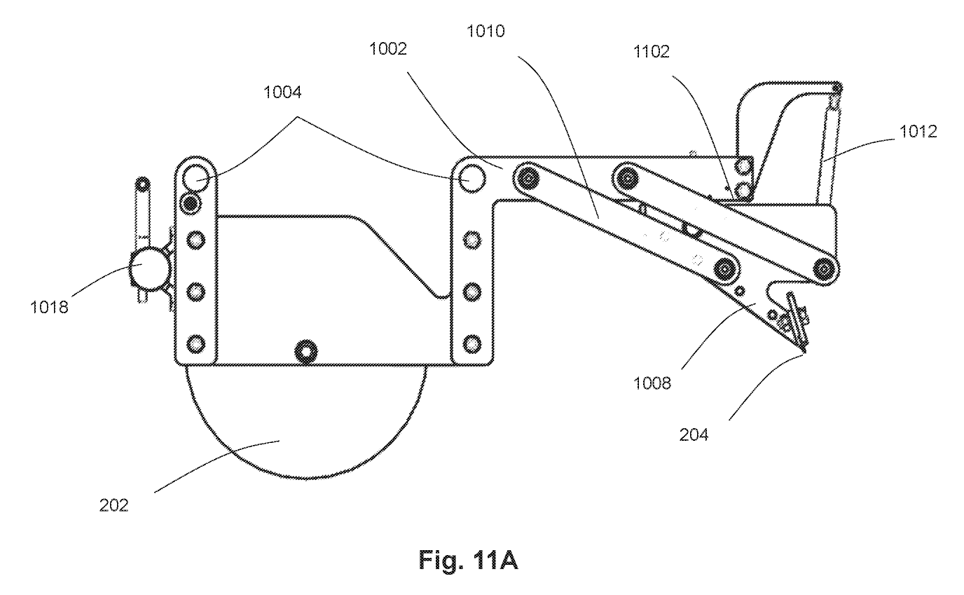

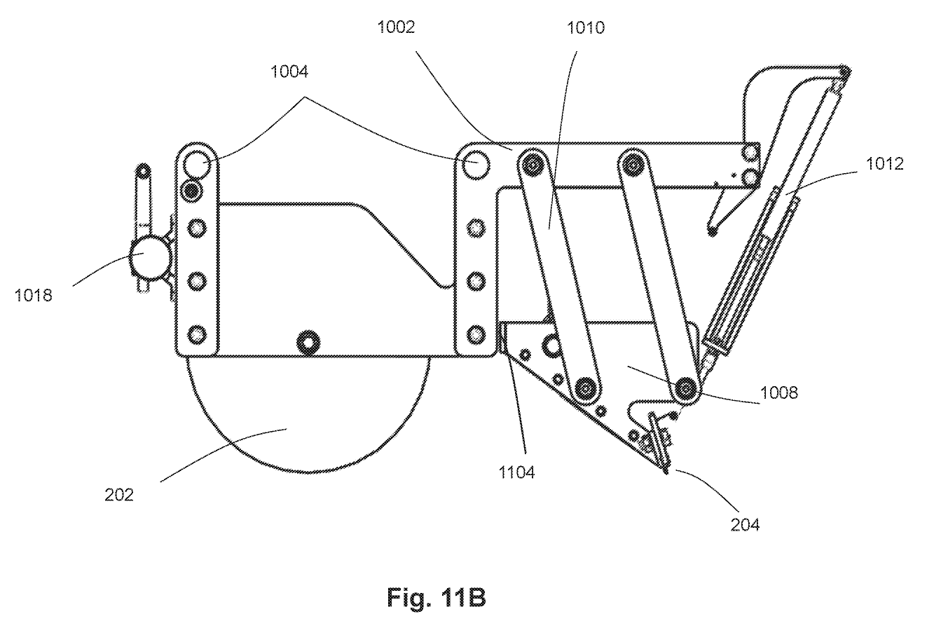

FIG. 11A schematically illustrates the cleaning head configuration of FIG. 10 with the wiper 204 retracted, and FIG. 11B schematically illustrates the cleaning head configuration of FIG. 10 with the wiper 204 in a fully downward position, according to some embodiments provided herein. Based upon wiper 204 being retracted (FIG. 11A), wiper frame 1008 can be pulled upward by cable 1014 shown in FIG. 10 until the wiper frame contacts frame structure 1002. Optionally, frame structure 1002 serves as a hard stop at the location designated 1102 in FIG. 11A. Based upon wiper 204 being extended downward (FIG. 11B), e.g., so as to engage with a solar panel, the wiper moves as far downward as the solar panel below it will allow. Based upon cleaning system 100 not being above a solar panel, wiper 204 can move downward until wiper frame 1008 contacts the frame structure 1002 1002 at the location designated 1104 in FIG. 11B.

FIG. 12 schematically illustrates an alternative configuration of part of cleaning head 200 from FIG. 2, according to some embodiments provided herein. In the non-limiting configuration illustrated in FIG. 12, brush 202 and the cleaning fluid deposition system can be the same as described elsewhere herein, and the cleaning head and cleaning system can be used similarly as described herein with reference to FIGS. 5 and 7. The alternatively configured cleaning head illustrated in FIG. 12 also includes wiper 1202 that can be mounted differently from wiper 204. For example, wiper 1202 can be configured so as to form an acute angle with a solar panel 102, and can be pulled along so as to clean the panel in the direction of travel, marked by the arrow 1204. Wiper 1202 can be mounted on a wiper plate 1206, which plate can be held by an arm 1208 connected to the center of the plate. Arm 1208 can be configured so as to provide an obtuse angle such that the section of the arm away from wiper 1202 can be substantially parallel to the solar panel and can be aligned with the direction of travel of the cleaning system 100. The arm 1208 can be connected to a rotary joint 1210 that allows rotation about axis 1212. In the illustrated configuration, this rotary joint 1210 can be connected to a bar 1214 that can be connected by any suitable number of links 1216, e.g., two links, to mounting structure 1218. Mounting structure 1218 can be connected to support structure 110 such as shown in FIG. 2, and can be positioned so that wiper 1202 trails rotating brush 202 as cleaning system 100 moves along the array of solar panels 102 to clean them.

Still referring to FIG. 12, in some configurations wiper 1202, wiper plate 1204, arm 1208, rotary joint 1210, and bar 1214 can all swing up and down, constrained by links 1216 which optionally can be configured so as to provide a four-bar linkage motion. Links 1216 can facilitate wiper 1202 so as to retract or lower to contact the solar panels array 102. Cable 1220 can be used to retract or lower wiper 1202. For example, cable 1220 can be pulled by a linear motor, a rotary motor, a pneumatic system, a hand crank, or other suitable mechanism. Bar 1214 can swing until the bar hits one or more hard stops on mounting structure 1218 or until the wiper 1202 contacts a solar panel 102. The rotation of links 1216 also or alternatively can provide other features. For example, links 1216 can facilitate wiper 1202 to adjust to solar panels at different heights than one another, while retaining a proper contact angle. Additionally, or alternatively, based upon a higher drag force is encountered by wiper 1202, the links 1216 can facilitate the wiper to be pushed slightly backward and upward. The upward movement can reduce normal force from the wiper 1202 onto the solar panel 102, thereby passively reducing drag forces. Additionally, or alternatively, a combination spring and damper 1222 (e.g., combination spring and dashpot) can act to press wiper 1202 against the solar panel surface and/or to retard motion to inhibit or prevent the accumulation of momentum. As with other configurations, such action(s) can help to inhibit or prevent the wiper plate 1206 from hitting an upcoming solar panel edge with too much force when the wiper 1202 transitions from one panel to the next one.

Continuing with FIG. 12, the rotary joint 1210 can facilitate wiper 1202 to conform to variations in the relative angles of the solar panels 102. In combination with the flexibility of the links 1216, the rotary joint 1210 also can aid in passively correcting for non-uniform drag forces along the length of the wiper 1202 in a similar way as the configuration in FIG. 10.

In one exemplary embodiment, a system for cleaning an array of solar panels is provided that includes a drive system movable along the array of solar panels, and a cleaning head coupled to the drive system and configured to sequentially clean the solar panels as the drive system moves along the array. The cleaning head can include a fluid emitter configured to deposit fluid onto the solar panels; a wiper; a wiper support structure; a first mechanical linkage; and a second mechanical linkage spaced apart from the first mechanical linkage. The first and second mechanical linkages respectively can couple first and second portions of the wiper to the wiper support structure partially independently of one another and partially independently of the wiper support structure such that the wiper sequentially substantially fully contacts each of the solar panels to wipe the deposited fluid from those solar panels as the drive system moves along the array. Nonlimiting examples of such an embodiment are provided herein, for example, with reference to FIGS. 1, 2A-2B, 3, 4, 5, 8A-8B, 9A-9B, 10, and 11A-11B.

Under another aspect, a method for cleaning an array of solar panels is provided that includes sequentially moving a cleaning head across the solar panels of the array, and depositing, by the cleaning head, fluid onto the solar panels. Additionally, the method includes, while sequentially moving the cleaning head across the solar panels of the array, sequentially removing, by a wiper of the cleaning head, the deposited fluid from respective solar panels. The cleaning head can include a wiper support structure, a first mechanical linkage, and a second mechanical linkage spaced apart from the first mechanical linkage. The first and second mechanical linkages respectively can couple first and second portions of the wiper to the wiper support structure partially independently of one another and partially independently of the wiper support structure such that the wiper sequentially substantially fully contacts each of the solar panels to wipe the deposited fluid from those solar panels as the cleaning head moves across the solar panels. Nonlimiting examples of such an embodiment are provided herein, for example, with reference to FIGS. 1, 2A-2B, 3, 4, 5, 8A-8B, 9A-9B, 10, and 11A-11B.

Under another aspect, a system for cleaning an array of solar panels is provided that includes a drive system movable along the array of solar panels; and a cleaning head coupled to the drive system so as to sequentially clean the solar panels as the drive system moves along the array. The cleaning head can include a fluid emitter configured to deposit fluid onto the solar panels; a wiper support structure including a first spring; and a wiper coupled to the cleaning head via the wiper support structure. The first spring can be configured to sequentially press the wiper downward against each of the solar panels so as to wipe the deposited fluid from those solar panels sequentially as the drive system moves along the array. Nonlimiting examples of such an embodiment are provided herein, for example, with reference to FIGS. 1, 2A-2B, 3, 4, 5, 8A-8B, 9A-9B, 10, 11A-11B, and 12.

Under yet another aspect, a method for cleaning an array of solar panels is provided that includes sequentially moving a cleaning head across the solar panels of the array; and depositing, by the cleaning head, fluid onto the solar panels. The method also can include, while sequentially moving the cleaning head across the solar panels of the array, sequentially pressing, by a first spring, a wiper of the cleaning head downward against respective solar panels so as to wipe the deposited fluid from those solar panels. Nonlimiting examples of such an embodiment are provided herein, for example, with reference to FIGS. 1, 2A-2B, 3, 4, 5, 8A-8B, 9A-9B, 10, 11A-11B, and 12.

Under still another aspect, a system for cleaning an array of solar panels is provided that includes a drive system movable along the array of solar panels; and a cleaning head coupled to the drive system so as to sequentially clean the solar panels as the drive system moves along the array. The cleaning head can include a fluid emitter configured to deposit fluid onto the solar panels; a wiper support structure including a first damper; and a wiper coupled to the cleaning head via the wiper support structure so as to sequentially wipe the deposited fluid from respective solar panels as the drive system moves along the array. The first damper can be configured to resist downward rotation of the wiper. Nonlimiting examples of such an embodiment are provided herein, for example, with reference to FIGS. 1, 2A-2B, 3, 4, 5, 8A-8B, 9A-9B, 10, 11A-11B, and 12.

Under yet another aspect, a method for cleaning an array of solar panels is provided that includes sequentially moving a cleaning head across the solar panels of the array, and depositing, by the cleaning head, fluid onto the solar panels. The method also can include, while sequentially moving the cleaning head across the solar panels of the array, sequentially removing, by a wiper of the cleaning head, the deposited fluid from respective solar panels, and resisting, by a first damper, downward rotation of the wiper. Nonlimiting examples of such an embodiment are provided herein, for example, with reference to FIGS. 1, 2A-2B, 3, 4, 5, 8A-8B, 9A-9B, 10, 11A-11B, and 12.

Under still another aspect, a system of cleaning a solar panel is provided. A surface of the solar panel can include a curvature. The system can include a cleaning head movable across the solar panel. The cleaning head can include a fluid emitter configured to deposit fluid onto the solar panel; a wiper support structure including first and second springs; and a wiper coupled to the first and second springs. The first and second springs can press the wiper into full contact with the surface, including the curvature, so as to wipe the deposited fluid from the solar panel as the cleaning head moves across the solar panel. Nonlimiting examples of such an embodiment are provided herein, for example, with reference to FIGS. 1, 2A-2B, 3, 4, 5, 8A-8B, 9A-9B, 10, and 11A-11B.

Under yet another aspect, a method for cleaning a solar panel is provided. A surface of the solar panel can include a curvature. The method can include moving a cleaning head across the solar panel, and depositing fluid onto the solar panel. The method also can include, while moving the cleaning head across the curved solar panel, sequentially pressing, by first and second springs, a wiper into full contact with the surface, including the curvature, so as to wipe the deposited fluid from the solar panel as the cleaning head moves across the solar panel. Nonlimiting examples of such an embodiment are provided herein, for example, with reference to FIGS. 1, 2A-2B, 3, 4, 5, 8A-8B, 9A-9B, 10, and 11A-11B.

Although specific embodiments of the present invention have been described, it will be understood by those of skill in the art that there are other embodiments that are equivalent to the described embodiments. For example, various embodiments and/or examples of the present invention can be combined. Accordingly, it is to be understood that the invention is not to be limited by the specific illustrated embodiments. All such changes and modifications that fall within the true spirit and scope of the invention are encompassed by the following claims.

1. A system for cleaning an array of solar panels, the system comprising:
a drive system movable along the array of solar panels; and
a cleaning head coupled to the drive system and configured to sequentially clean the solar panels as the drive system moves along the array, the cleaning head comprising:
a fluid emitter configured to deposit fluid onto the solar panels;
a wiper;
a wiper support structure;
a first mechanical linkage; and
a second mechanical linkage spaced apart from the first mechanical linkage,
wherein the first and second mechanical linkages respectively couple first and second portions of the wiper to the wiper support structure partially independently of one another and partially independently of the wiper support structure such that the wiper sequentially substantially fully contacts each of the solar panels to wipe the deposited fluid from those solar panels as the drive system moves along the array.

2. The system of claim 1, wherein the first and second mechanical linkages respectively comprise first and second hinges each rotatable about a respective axis.

3. The system of claim 2, wherein the first and second hinges respectively are configured to inhibit movement of the first and second portions of the wiper about another respective axis.

4. The system of claim 2, wherein responsive to the first section of the wiper experiencing an increased drag force, the first portion of the wiper rotates via the first hinge to reduce the drag force.

5. The system of claim 1, wherein:
the first mechanical linkage comprises first and second links; and
the second mechanical linkage comprises third and fourth links.

6. The system of claim 5, wherein the first, second, third, and fourth links are configured to inhibit movement of the wiper about an axis.

7. The system of claim 5, wherein responsive to the first section of the wiper experiencing an increased drag force, the first portion of the wiper rotates via the first and second linkages to reduce the drag force.

8. The system of claim 1, wherein the first portion of the wiper comprises a first end of the wiper, and wherein the second portion of the wiper comprises a second end of the wiper.

9. The system of claim 1, further comprising a third mechanical linkage spaced apart from and disposed between the first and second mechanical linkages.

10. The system of claim 1, wherein the cleaning head further comprises a spring configured to press the wiper downward against respective surfaces as the drive system moves along the array.

11. The system of claim 1, wherein the cleaning head further comprises a damper configured to resist downward motion of the wiper.

12. The system of claim 11, wherein the damper is configured to retard a swinging motion of the wiper at gaps between the solar panels as the drive system moves along the array.

13. A method for cleaning an array of solar panels, the method comprising:
sequentially moving a cleaning head across the solar panels of the array;
depositing, by the cleaning head, fluid onto the solar panels;
while sequentially moving the cleaning head across the solar panels of the array, sequentially removing, by a wiper of the cleaning head, the deposited fluid from respective solar panels,
wherein the cleaning head comprises a wiper support structure, a first mechanical linkage, and a second mechanical linkage spaced apart from the first mechanical linkage; and
wherein the first and second mechanical linkages respectively couple first and second portions of the wiper to the wiper support structure partially independently of one another and partially independently of the wiper support structure such that the wiper sequentially substantially fully contacts each of the solar panels to wipe the deposited fluid from those solar panels as the cleaning head moves across the solar panels.

14. The method of claim 13, wherein the first and second mechanical linkages respectively comprise first and second hinges each rotatable about a respective axis.

15. The method of claim 14, wherein the first and second hinges respectively inhibit movement of the first and second portions of the wiper about another a respective axis.

16. The method of claim 14, wherein responsive to the first section of the wiper experiencing an increased drag force, the first portion of the wiper rotates via the first hinge to reduce the drag force.

17. The method of claim 13, wherein:
the first mechanical linkage comprises first and second links; and
the second mechanical linkage comprises third and fourth links.

18. The method of claim 17, wherein the first, second, third, and fourth links inhibit movement of the wiper about an axis.

19. The method of claim 17, wherein responsive to the first section of the wiper experiencing an increased drag force, the first portion of the wiper rotates via the first and second linkages to reduce the drag force.

20. The method of claim 13, wherein the first portion of the wiper comprises a first end of the wiper, and wherein the second portion of the wiper comprises a second end of the wiper.

21. The method of claim 13, wherein the cleaning head further comprises a third mechanical linkage spaced apart from and disposed between the first and second mechanical linkages.

22. The method of claim 13, wherein the cleaning head further comprises a spring pressing the wiper downward against respective surfaces as the cleaning head moves across the solar panels of the array.

23. The method of claim 13, wherein the cleaning head further comprises a damper resisting downward motion of the wiper.

24. The method of claim 23, wherein the damper retards a swinging motion of the wiper at gaps between the solar panels as the cleaning head moves across the solar panels of the array.

25-56. (canceled)
